(19) United States
(12) Patent Application Publication
(10) Pub. No.: US 2011/0148747 A1
(43) Pub. Date: Jun. 23, 2011

(54) Multi-primary color display and the manufacturing method thereof

(75) Inventors: Guo-Feng Uei, Hsin-Chu (TW); Chih-Cheng Chan, Hsin-Chu (TW)

(73) Assignee: AU OPTRONICS CORP., Hsin-Chu (TW)

(21) Appl. No.: 12/929,971

(22) Filed: Feb. 28, 2011

Related U.S. Application Data
(62) Division of application No. 12/078,773, filed on Apr. 4, 2008.

(30) Foreign Application Priority Data
Sep. 28, 2007 (TW) 96136404

(51) Int. Cl. G09G 3/34; H01J 9/24

(52) U.S. Cl. 345/84; 445/24

(57) ABSTRACT

A multi-primary color display has pixels, and each pixel includes at least four sub pixels which display red primary color, green primary color, blue primary color and cyan primary color, respectively. When the four primary colors are displayed to achieve white balance, their luminance ratios are: the relative luminance of green primary color is greater than the relative luminance of red primary color, the relative luminance of red primary color is greater than the relative luminance of cyan primary color, and the relative luminance of cyan primary color is greater than the relative luminance of blue primary color. A method for manufacturing the multi-primary color display is disclosed as well.

### RELATED APPLICATIONS

The present application is a division of application Ser. No. 12/078,773 filed Apr. 4, 2008, entitled “MULTI-PRIMARY COLOR DISPLAY AND THE MANUFACTURING METHOD THEREOF,” currently pending; which claims priority to Taiwan Patent Application Serial Number 96136404, filed Sep. 28, 2007. All of these applications are incorporated herein by reference.

### BACKGROUND OF THE INVENTION

1. Field of Invention

The invention relates to a display device and, in particular, to a multi-primary color display.

2. Related Art

With advances in technology, people have higher requirements for color presentations in the display, hoping that the display can present more abundant and saturated colors. Normal displays only use three primary colors (e.g., the red, green and blue primary colors) to produce desired colors. However, such three-primary color displays cannot produce all colors in nature, particularly the sky blue and golden yellow. A solution in the prior art is to increase the saturation of these three primary colors in order to enlarge their gamut range. Nevertheless, the effect of this method is very limited. The display brightness may be reduced due to the properties of the display itself. Another solution is to add another new primary color that is different from the red, green, and blue primary colors. The newly added primary color falls outside the triangular gamut range enclosed by the red, green, and blue primary colors on the CIE1931 chromatic diagram. This method can indeed effectively increase the gamut range of the display and keep or even enhance the brightness thereof.

### SUMMARY OF THE INVENTION

According to one embodiment of the invention, the display device includes a plurality of pixels, each of which has at least four sub pixels for the red, green, blue, and cyan primary colors. When the four primary colors achieve the white balance, their relative luminances satisfy the following relations: the relative luminance of green primary color is greater than the relative luminance of red primary color, the relative luminance of red primary color is greater than the relative luminance of cyan primary color, and the relative luminance of cyan primary color is greater than the relative luminance of blue primary color.

According to another embodiment of the invention, the display device includes a plurality of pixels, each of which has at least four sub pixels for the red, green, blue, and yellow primary colors. When the four primary colors achieve the white balance, their relative luminances satisfy the following relations: the relative luminance of green primary color is greater than the relative luminance of yellow primary color, the relative luminance of yellow primary color is greater than the relative luminance of red primary color, and the relative luminance of red primary color is greater than the relative luminance of blue primary color.

In accord with one embodiment of the invention, a method for manufacturing a display device involves the step of forming a pixel array. Each pixel include at least four sub pixels for displaying red, green, blue, and cyan primary colors. When the four primary colors achieve the white balance, their relative luminances satisfy the following relations: the relative luminance of green primary color is greater than the relative luminance of red primary color, the relative luminance of red primary color is greater than the relative luminance of cyan primary color, and the relative luminance of cyan primary color is greater than the relative luminance of blue primary color.

In accord with another embodiment of the invention, a method for manufacturing a display device involves the step of forming a pixel array. Each pixel include at least four sub pixels for displaying red, green, blue, and yellow primary colors. When the four primary colors achieve the white balance, their relative luminances satisfy the following relations: the relative luminance of green primary color is greater than the relative luminance of yellow primary color, the relative luminance of yellow primary color is greater than the relative luminance of red primary color, and the relative luminance of red primary color is greater than the relative luminance of blue primary color.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

These and other features, aspects and advantages of the invention will become apparent by reference to the following description and accompanying drawings which are given by way of illustration only, and thus are not limitative of the invention, and wherein:

FIGS. 1 and 2 are diagrams showing the gamut space of two different experiments obtained following the simulation steps;

FIG. 3 is a schematic view of a display device according to one embodiment of the invention;

FIG. 4 is a flowchart of the method for manufacturing a display device according to another embodiment of the invention;

FIG. 5 shows the relationship of the relative luminance in different experiments of the first embodiment; and

FIG. 6 shows the relationship of the relative luminance in different experiments of the second embodiment.

### DETAILED DESCRIPTION OF THE INVENTION

The present invention will be apparent from the following detailed description, which proceeds with reference to the accompanying drawings, wherein the same references relate to the same elements.

The use of multiple primary colors provides more freedom in achieving the white balance. There can be better combinations of the primary colors to meet different needs by adjusting the relative luminances of them. The following embodiments of the invention disclose the relationship between the relative luminances of primary colors and the gamut range of natural colors. Not only can more natural colors be covered, the following embodiments of the invention can also achieve the coverage balance in the colors.

In the disclosed four-primary color display, the chromatic coordinates of the primary colors and the white point (W) are known. The relative luminance of each primary color (e.g., the new primary color V) is also known. Then one can use Eq. (1) below to obtain the relative luminances of the rest three primary colors (e.g., the red, green, and blue primary colors).

$$[ \begin{matrix}{Y}_{R} \\ {Y}_{G} \\ {Y}_{B}\end{matrix} ] = {[ \begin{matrix}\frac{{x}_{R}}{{y}_{R}} & \frac{{x}_{G}}{{y}_{G}} & \frac{{x}_{B}}{{y}_{B}} \\ 1 & 1 & 1 \\ \frac{{z}_{R}}{{y}_{R}} & \frac{{z}_{G}}{{y}_{G}} & \frac{{z}_{B}}{{y}_{B}}\end{matrix} ]}^{- 1} \times [ \begin{matrix}\frac{{x}_{W}}{{y}_{W}} - \frac{{x}_{V}}{{y}_{V}} {Y}_{V} \\ 1 - {Y}_{V} \\ \frac{{z}_{W}}{{y}_{W}} - \frac{{z}_{V}}{{y}_{V}} {Y}_{V}\end{matrix} ] , \qquad ( 1 )$$

where xᵢ, yᵢ are the chromatic coordinates of the primary color i and Yᵢ is the relative luminance of the primary color I (normalized to the white point).

The disclosed embodiment uses a simulation method to simulate in a four-primary color environment the changes in the chromatic coordinates the primary colors and the white point (white balance) and the luminance ratio of a particular primary color relative to the white. These experiments are used to observe the difference between the gamut formed under the LCH coordinate system and the natural color gamut, thereby inferring the relationship between the relative luminances of primary colors of the multiple primary color display and the gamut coverage of natural colors.

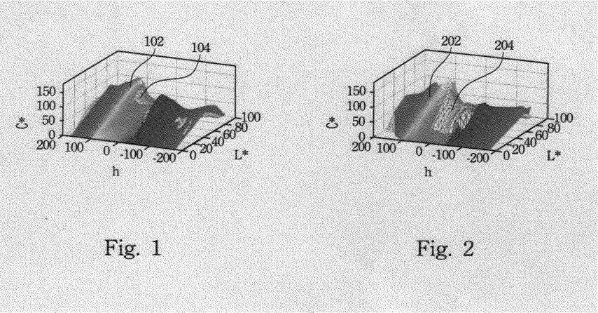

More explicitly, in the three-dimensional space of the LCH coordinate system, the profile of the gamut boundary (i.e., the gamut range formed in the experiment) varies with changes in the relative luminances of primary colors. FIGS. 1 and 2 are the chromatic diagrams obtained in two experiments following the simulation steps mentioned above. They illustrate that by varying the relative luminance ratios of the primary colors, the gamut thus formed has a better coverage over the gamut of natural colors. In these two plots, the large-area dark curved surfaces 102, 202 are the gamut ranges formed by the four primary colors, whereas the meshed regions 104, 204 are the gamut range of natural colors. They are exposed because the gamut ranges 102, 202 formed by the four primary colors cannot cover the entire region. By comparing the two drawings, it is clear that the gamut range formed in FIG. 1 has a better coverage than that formed in FIG. 2.

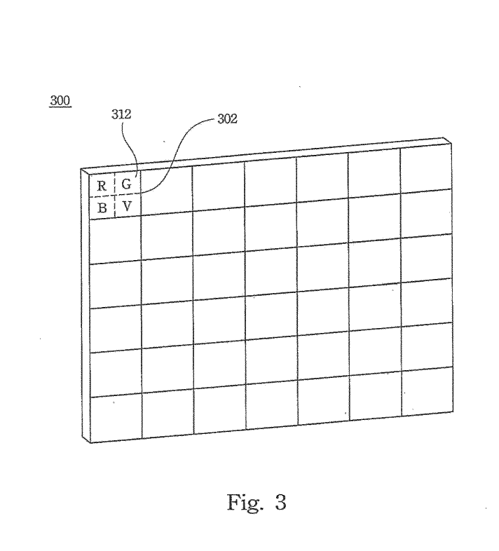

FIG. 3 is a schematic view of a display device according to one embodiment of the invention. The display device 300 includes a plurality of pixels 302, each of which has at least four sub pixels 312 for the red primary color (R), the green primary color (G), the blue primary color (B), and the new primary color (V). For example, the display device 300 is a flat-panel display, such as a self-illuminating display device (organic light-emitting display) or a display that requires a backlight source (liquid crystal display).

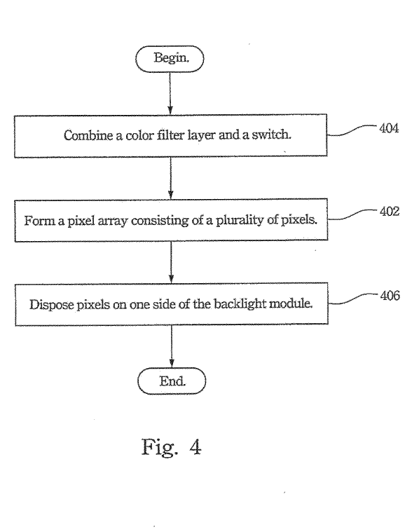

FIG. 4 is a flowchart of the method for manufacturing a display device according to another embodiment of the invention. Please also refer to FIG. 3 at the same time. Several pixels 302 are formed in a pixel array (step 402). Each pixel 302 has at least four sub pixels 312 for displaying the red primary color (R), the green primary color (G), the blue primary color (B), and the new primary color (V).

For example, when the display device 300 requires a backlight source, the pixels 302 can be formed by combining a color filter layer with a switch (not shown) (step 404). The switch can be a liquid crystal device or some other suitable light shutter. These pixels 302 are disposed on one side of the backlight source (not shown) of the display device 300 (step 406) in order to display the red primary color (R), the green primary color (G), the blue primary color (B), and the new primary color (V).

The following two embodiments employ the above-mentioned simulation method. During the simulation, each experiment first assumes the relative luminance of the new primary color (cyan or yellow) to be, for example, 0.1, 0.2 or 0.3. Then Eq. (1) is used to obtain the relative luminances of the red, green, and blue primary colors. Afterwards, one determines whether the gamut range thus formed has a good coverage over the gamut of natural colors.

From the simulation results of many experiments, it is possible to obtain the relationship between the relative luminance of the new primary color and the red, green, and blue primary colors on the premises that a larger gamut of natural colors is covered and the coverage balance of various colors is achieved.

### First Embodiment

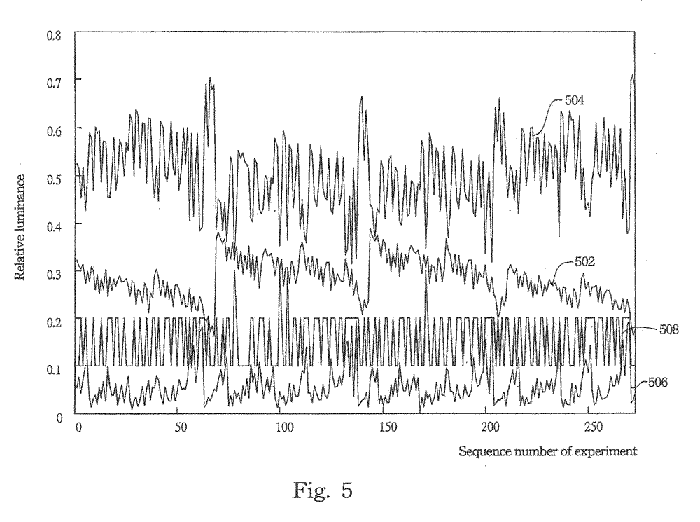

FIG. 5 shows the relative luminances in different experiments of the first embodiment. The vertical axis is the relative luminance ratio of a particular primary color to the white. The horizontal axis is the sequence number of the 273 sets of experiments. In FIG. 5, line 502 is the relative luminance of red primary color, line 504 is that of green primary color, line 506 is that of blue primary color, and line 508 is that of cyan primary color.

TABLE 1
Reference chromatic coordinates of various primary colors.

| | X chromatic coordinate | Y chromatic coordinate |
|---|---|---|
| Red | 0.696 | 0.29 |
| Green | 0.268 | 0.686 |
| Blue | 0.135 | 0.075 |
| Cyan | 0.148 | 0.429 |
| White Point 1 | 0.313 | 0.329 |
| White Point 2 | 0.28 | 0.29 |

Table 1 lists the reference chromatic coordinates of various primary colors. Each experiment set selects the chromatic coordinates of the primary colors from the surroundings of these reference chromatic coordinates for simulations. Under the considerations of gamut coverage in natural colors and the coverage balance of different colors, the experiments satisfying the requirements are depicted in FIG. 5.

According to FIG. 5, when the new primary color is cyan, the relative luminances of the primary colors satisfy the following relations:

the relative luminance of green primary color is greater than the relative luminance of red primary color, the relative luminance of red primary color is greater than the relative luminance of cyan primary color, and the relative luminance of cyan primary color is greater than the relative luminance of blue primary color.

Moreover,

0.162≦the relative luminance of red primary color≦0.388;

0.315≦the relative luminance of green primary color≦0.709;

0.003≦the relative luminance of blue primary color≦0.197; and

0.1≦the relative luminance of cyan primary color≦0.3.

### Second Embodiment

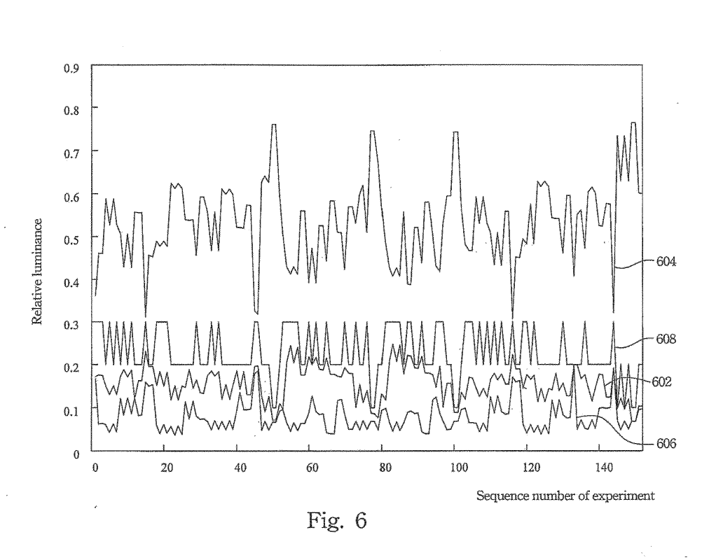

FIG. 6 shows the relative luminances in different experiments of the second embodiment. The vertical axis is the relative luminance ratio of a particular primary color to the white. The horizontal axis is the sequence number of the 152 sets of experiments. In FIG. 6, line 602 is the relative luminance of red primary color, line 604 is that of green primary color, line 606 is that of blue primary color, and line 608 is that of yellow primary color.

TABLE 2
Reference chromatic coordinates of various primary colors.

| | X chromatic coordinate | Y chromatic coordinate |
|---|---|---|
| Red | 0.692 | 0.28 |
| Green | 0.208 | 0.672 |
| Blue | 0.125 | 0.055 |
| Cyan | 0.499 | 0.493 |
| White Point 1 | 0.313 | 0.329 |
| White Point 2 | 0.28 | 0.29 |

Table 2 lists the reference chromatic coordinates of various primary colors. Each experiment set selects the chromatic coordinates of the primary colors from the surroundings of these reference chromatic coordinates for simulations. Under the considerations of gamut coverage in natural colors and the coverage balance of different colors, the experiments satisfying the requirements are depicted in FIG. 6.

According to FIG. 6, when the new primary color is yellow, the relative luminances of the primary colors satisfy the following relations:

the relative luminance of green primary color is greater than the relative luminance of yellow primary color, the relative luminance of yellow primary color is greater than the relative luminance of red primary color, and the relative luminance of red primary color is greater than the relative luminance of blue primary color.

Moreover,

0.068≦the relative luminance of red primary color≦0.247;

0.307≦the relative luminance of green primary color≦0.764;

0.037≦the relative luminance of blue primary color≦0.192; and

0.1≦the relative luminance of yellow primary color≦0.3.

In summary, although the chromatic coordinates of the primary colors may vary due to manufacturing processes, material limitations, and other factors, the relative luminances of the primary colors stay the same. Although a larger gamut range may be obtained by adjusting the relative luminance ratios, the overall performance may sacrifice and the saturations in certain colors are insufficient.

Through the above-mentioned simulation process, not only can the above-mentioned embodiments avoid possible blind spots in the CIE1931 chromatic diagram, various primary colors can be adjusted according to different needs to achieve a set of optimized luminance ratios.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display device, comprising:
a plurality of pixels, each of which has at least four sub pixels for displaying red primary color, green primary color, blue primary color, and yellow primary color whose relative luminances at the white balance of the four primary colors satisfy the following relations:
the relative luminance of green primary color is greater than the relative luminance of yellow primary color, the relative luminance of yellow primary color is greater than the relative luminance of red primary color, and the relative luminance of red primary color is greater than the relative luminance of blue primary color.

2. The display device of claim 1, wherein
0.068≦the relative luminance of red primary color≦0.247;
0.307≦the relative luminance of green primary color≦0.764;
0.037≦the relative luminance of blue primary color≦0.192; and
0.1≦the relative luminance of yellow primary color≦0.3.

3. The display device of claim 1, wherein the chromatic coordinates of the white balance in the CIE1931 chromatic diagram is (x, y)=(0.313, 0.329) or (0.28, 0.29).

4. A method for manufacturing a display device, comprising the step of forming a pixel array with a plurality of pixels, each of which has at least four sub pixels for displaying red primary color, green primary color, blue primary color, and yellow primary color whose relative luminances at the white balance of the four primary colors satisfy the following relations:
the relative luminance of green primary color is greater than the relative luminance of yellow primary color, the relative luminance of yellow primary color is greater than the relative luminance of red primary color, and the relative luminance of red primary color is greater than the relative luminance of blue primary color.

5. The method of claim 4, wherein
0.068≦the relative luminance of red primary color≦0.247;
0.307≦the relative luminance of green primary color≦0.764;
0.037≦the relative luminance of blue primary color≦0.192; and
0.1≦the relative luminance of yellow primary color≦0.3.

6. The method of claim 4, wherein the chromatic coordinates of the white balance in the CIE1931 chromatic diagram is (x, y)=(0.313, 0.329) or (0.28, 0.29).

7. The method of claim 4, further comprising the steps of:
combining a color filter layer and a switch to forming the pixels; and
disposing the pixels on one side of a backlight source.
